(19) United States
(12) Patent Application Publication
(10) Pub. No.: US 2009/0175521 A1
(43) Pub. Date: Jul. 9, 2009

(54) Method and System for Creating and Embedding Information in Digital Representations of a Subject

(75) Inventors: Kamyar F. Shadan, Tiburon, CA (US); Paul Bertucci, Eugene, OR (US)

Correspondence Address: WILSON SONSINI GOODRICH & ROSATI, 650 PAGE MILL ROAD, PALO ALTO, CA, 94304-1050, US

(73) Assignee: DIGINOME, INC., Novato, CA (US)

(21) Appl. No.: 12/042,263

(22) Filed: Mar. 4, 2008

Related U.S. Application Data
(60) Provisional application No. 61/019,556, filed on Jan. 7, 2008.

(51) Int. Cl. G06K 9/46

(52) U.S. Cl. 382/129

(57) ABSTRACT

Provided herein is a method for creating an adaptable digital representation of a subject, comprising: inputting into a computer system information sufficient to form a digital representation of the subject; deriving a digital representation of the subject based on the information; assigning traits to the digital representation; encoding the representation with the traits of the digital representation creating an encoded representation; and storing the encoded representation.

### CROSS-REFERENCE

This application claims the benefit of U.S. Provisional Application No. 61/019,556, filed Jan. 7, 2008, the contents of which are incorporated herein by reference in their entirety.

### FIELD OF THE INVENTION

This application relates to a method, and system for creating a digital representation of a subject and uses thereof, and embedding information into the digital representation and more specifically, for embedding data concerning the traits of the digital representation.

### BACKGROUND OF THE INVENTION

Gaming is an increasingly popular pastime. There are generally two types of gaming systems. The first is the traditional console-based gaming system. Examples are Nintendo's Wii®, Microsoft's X-Box®, and Sony's Playstation®. Several games for the console-based systems allow users to interact with other users through internet connections. One such example is HALO® 3 which, in its first week, had estimated sales of $300 million. HALO® 3 is a first person shooter game where the player sees through the eyes of his avatar and other players see and interact with the avatars of fellow players.

There are also online computer role-playing games such as World of Warcraft® where players need only purchase the software to play. Currently, World of Warcraft® has approximately 8.5 millions users. The estimated 2007 revenues are $1.1 billion, with $520 million in operating profits. World of Warcraft® also involves the use of avatars to represent players.

Multiple online social networking sites exist. The most popular are Myspace® and Facebook®. It is estimated that 12% of internet users are registered at a social networking site. Facebook® alone is estimated to have over 15 million users. Both sites allow users to upload photographs as a method of identifying themselves.

Virtual reality simulations are an amalgam of social networking sites and online game playing. Sites such as Second Life® create online communities with rules similar to the real world where users interact with each other. Users are represented by avatars and interact with the avatars of other users.

According to U.S. Census Bureau estimates, in the 1^{st} quarter of 2007 eCommerce sales totaled $31.4 billion. Second quarter sales totaled $33.6 billion. Third quarter sales totaled $34.7 billion. According to White House estimates annually approximately 10 million people are victims of identity theft. Losses often total $50 billion or more. There are many ways a person's identity may be stolen such as by use of spyware, viruses, or hackers breaching a secure network.

Family planning often requires pre-pregnancy screening for several genetic diseases which may be genetically inherited. Ty-Sachs disease, Sickle Cell Anemia, and Cystic Fibrosis are all autosomal recessive disorders which may be inherited when both parents posses a single copy of the defective gene. Hemophilia is an example of an X-linked recessive disorder which may be inherited by a male child if the mother possesses a single copy or by a female child if both the mother and father possess a single copy.

Facial recognition software identifies individuals based on a two-dimensional image captured from a video frame or digital image. Identifications are made by comparing certain facial features and measurements from the image in the database to the features and measurement in the video frame or digital image. Examples of features include the distance between eyes, the width of the nose, the depth of the eye sockets, the shape of cheekbones, and the width of the jaw line.

### SUMMARY OF THE INVENTION

In some embodiments, the invention comprises a method for creating an adaptable digital representation of a subject. In some embodiments, the creation of the digital representation comprises inputting, into a computer system, information sufficient to form a digital representation of the subject. In some embodiments, a digital representation of the subject is derived from the information. In some embodiments, the creation of the digital representation also comprises assigning traits to the digital representation.

In some embodiments, the creation of the digital representation further comprises encoding the representation with the traits and thus creating an encoded representation. In some embodiments, the creation of the digital representation further comprises storing the encoded representation.

In some embodiments, the information sufficient to form a digital representation of the subject is selected from the group consisting of: a single 2-D image of the subject, multiple 2-D images of the subject, Computer Axial Tomography scans of the subject, 3-D scans of the subject, and biological samples of the subject.

In some embodiments, the traits of the digital representation are selected from the group consisting of: the time the digital representation is created; the time a modification, enhancement, or supplement is made; identification of a modification, enhancement, or supplement; identification of the author of a modification, enhancement, or supplement; how a modification, enhancement, or supplement was made; the time a clone of the digital representation is made; who made a clone; where the clone was utilized; and security or access information.

In some embodiments, the digital representation is a three-dimensional likeness of the subject. In some embodiments, the three-dimensional likeness is extrapolated from the inputted information. In some embodiments, the digital representation is a representation of the subject's DNA.

In some embodiments, the subject is a living organism. In some embodiments, the subject is a human being.

In some embodiments, the information derived from the two-dimensional images or three-dimensional scans is selected from the group consisting of: hair color, hair texture, hair length, location of the hair line, eye color, eye size, eye shape, eye location, nose shape, nose location, mouth shape, mouth size, mouth location, head shape, head size, ear location, skin texture, and skin color. In some embodiments, genetic information is extrapolated from physical characteristics.

In some embodiments, the digital representation of the human being is enhanced or supplemented by additional information concerning physical characteristics and biometrics of the subject. In some embodiments, the additional information is selected from the group consisting of: age, height, weight, body mass, finger prints, retinal scans, blood type, voice patterns, gender, birth date, blood sugar levels, blood pressure, and cholesterol levels.

In some embodiments, the digital representation is continuously or periodically modified, enhanced, or supplemented while the records of the prior embodiments of the digital representation are preserved. In some embodiments, the digital representation is modified, enhanced, or supplemented by user input. In some embodiments, the digital representation is automatically modified, enhanced, or supplemented by the system.

In some embodiments, the system periodically mines for information related to the subject. In some embodiments, the information is mined from sources selected from the group consisting of: the internet, private databases, and public databases. In some embodiments, the system automatically modifies, enhances, or supplements the digital representation based upon the mined information.

In some embodiments, the digital representation of the subject is linked to any information used to modify, enhance, or supplement the representation.

In some embodiments, the invention comprises a method of using a digital representation of a subject created by the process comprising: inputting, into a computer system, information sufficient to form a digital representation of the subject; deriving a digital representation of the subject from the information; assigning traits to the digital representation; encoding the representation with the traits and thus creating an encoded representation; and storing the encoded representation.

In some embodiments the use of the digital representation is selected from the group consisting of: family planning, trait recognition, dating, complex identity recognition and validation, DNA matching, eCommerce, virtual reality simulations, social networking, health and fitness analysis and monitoring, gaming, and child protection and identification.

In some embodiments, the information sufficient to form a digital representation of the subject is selected from the group consisting of: a single 2-D image of the subject, multiple 2-D images of the subject, Computer Axial Tomography scans of the subject, 3-D scans of the subject, and biological samples of the subject.

In some embodiments, the traits of the digital representation are selected from the group consisting of: the time the digital representation is created; the time a modification, enhancement, or supplement is made; identification of a modification, enhancement, or supplement; identification of the author of a modification, enhancement, or supplement; how a modification, enhancement, or supplement was made; the time a clone of the digital representation is made; who made a clone; where the clone was utilized; and security or access information.

In some embodiments, the digital representation is a three-dimensional likeness of the subject. In some embodiments, the three-dimensional likeness is extrapolated from the inputted information. In some embodiments, the digital representation is a representation of the subject's DNA.

In some embodiments, the subject is a living organism.

In some embodiments, the subject is a human being.

In some embodiments, the digital representation is cloned.

In some embodiments, the clone is given a certificate value of its own.

In some embodiments, the clone is encoded with traits.

In some embodiments, the clone is uploaded into a virtual reality simulation. In some embodiments, the virtual reality simulation is Second Life®.

In some embodiments, the clone is uploaded into a social networking website. In some embodiments, the social networking website is selected from the group consisting of: Windows Live®, Myspace®, and Facebook®.

In some embodiments, the clone is uploaded into a game system. In some embodiments, the clone is used as the avatar which represents the subject in a game system. In some embodiments, the game system is selected from the group consisting of: X-box®, Nintendo Wii®, and Playstation®.

In some embodiments, the clone is used as the avatar which represents the subject in online computer role-playing games. In some embodiments, the online computer role-playing games are selected from the group consisting of: World of Warcraft®, Guild Wars®, the Lord of the Rings Online®, the Matrix Online®, Star Wars Galaxies®, and Stargate Worlds®.

In some embodiments, the invention comprises a system capable of generating an adaptable digital representation of a subject. In some embodiments, the creation of the digital representation comprises inputting, into a computer system, information sufficient to form a digital representation of the subject. In some embodiments, a digital representation of the subject is derived from the information. In some embodiments, the system also comprises an encoder coupled to the code generator, the encoder encoding the representation with the traits of the digital representation. In some embodiments, the system also comprises a rules engine, which classifies the traits into codes. In some embodiments, the system also comprises a storage unit coupled to the encoder, the storage unit storing the encoded representation.

In some embodiments, the information sufficient to form a digital representation of the subject is selected from the group consisting of: a single 2-D image of the subject, multiple 2-D images of the subject, Computer Axial Tomography scans of the subject, 3-D scans of the subject, and biological samples of the subject.

In some embodiments, the traits of the digital representation are selected from the group consisting of: the time the digital representation is created; the time a modification, enhancement, or supplement is made; identification of a modification, enhancement, or supplement; identification of the author of a modification, enhancement, or supplement; how a modification, enhancement, or supplement was made; the time a clone of the digital representation is made, who made a clone, where the clone was utilized, and security or access information.

In some embodiments, a decoder is coupled to the storage unit, the decoder to decode the encoded representation. In some embodiments, the decoding of the encoded representation reveals the traits of the digital representation.

In some embodiments, the invention comprises a computer readable medium having an executable program stored thereon, wherein, in response to the inputting of sufficient information about a subject, the program comprises the steps of: deriving a digital representation of the subject; generating a code indicating information regarding the traits of the digital representation; encoding the digital representation by embedding the code in the digital representation; and storing the digital representation in a storage unit.

In some embodiments, the traits of the digital representation are selected from the group consisting of: the time the digital representation is created; the time a modification, enhancement, or supplement is made; identification of a modification, enhancement, or supplement; identification of the author of a modification, enhancement, or supplement; how a modification, enhancement, or supplement was made; the time a clone of the digital representation is made; who made a clone; where the clone was utilized; and security or access information.

In some embodiments, the program further comprises the step of decoding the digital representation to reveal the traits of the digital representation.

In some embodiments, the step of encoding the digital representation in the program includes embedding the code in the bit plane of the digital representation.

In some embodiments, the certificate value of the digital representation is also encoded in the bit plane of the digital representation.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

FIGS. 1-22 illustrate embodiments of the invention. In particular:

FIG. 1 illustrates the process of creating a digital representation of a human subject.

FIG. 2 is a block diagram illustrating a system for data encoding in accordance with the present invention.

### DETAILED DESCRIPTION OF THE INVENTION

Provided herein are methods and systems for creating a digital representation of a subject, wherein the history of the representation is recorded. Methods of use for the representation are also provided.

In some embodiments, the invention comprises a method for creating an adaptable digital representation of a subject. In some embodiments, the creation of the digital representation comprises inputting, into a computer system, information sufficient to form a digital representation of the subject. In some embodiments, a digital representation of the subject is derived from the information. In some embodiments, the creation of the digital representation also comprises assigning traits to the digital representation.

In some embodiments, the creation of the digital representation further comprises encoding the representation with the traits and thus creating an encoded representation. In some embodiments, the creation of the digital representation further comprises storing the encoded representation.

In some embodiments, the information sufficient to form a digital representation of the subject is selected from the group consisting of: a single 2-D image of the subject, multiple 2-D images of the subject, Computer Axial Tomography scans of the subject, 3-D scans of the subject, and biological samples of the subject.

In some embodiments, the traits of the digital representation are selected from the group consisting of: the time the digital representation is created; the time a modification, enhancement, or supplement is made; identification of a modification, enhancement, or supplement; identification of the author of a modification, enhancement, or supplement; how a modification, enhancement, or supplement was made; the time a clone of the digital representation is made; who made a clone; where the clone was utilized; and security or access information.

In some embodiments, the digital representation is a three-dimensional likeness of the subject. In some embodiments, the three-dimensional likeness is extrapolated from the inputted information. In some embodiments, the digital representation is a representation of the subject's DNA.

In some embodiments, the subject is a living organism. In some embodiments, the subject is a human being.

In some embodiments, the information derived from the two-dimensional images or three-dimensional scans is selected from the group consisting of: hair color, hair texture, hair length, location of the hair line, eye color, eye size, eye shape, eye location, nose shape, nose location, mouth shape, mouth size, mouth location, head shape, head size, ear location, skin texture, and skin color. In some embodiments, genetic information is extrapolated from physical characteristics.

In some embodiments, the digital representation of the human being is enhanced or supplemented by additional information concerning physical characteristics and biometrics of the subject. In some embodiments, the additional information is selected from the group consisting of: age, height, weight, body mass, finger prints, retinal scans, blood type, voice patterns, gender, birth date, blood sugar levels, blood pressure, and cholesterol levels.

In some embodiments, the digital representation is continuously or periodically modified, enhanced, or supplemented while the records of the prior embodiments of the digital representation are preserved. In some embodiments, the digital representation is modified, enhanced, or supplemented by user input. In some embodiments, the digital representation is automatically modified, enhanced, or supplemented by the system.

In some embodiments, the system periodically mines for information related to the subject. In some embodiments, the information is mined from sources selected from the group consisting of: the internet, private databases, and public databases. In some embodiments, the system automatically modifies, enhances, or supplements the digital representation based upon the mined information.

In some embodiments, the digital representation of the subject is linked to any information used to modify, enhance, or supplement the representation.

In some embodiments, the invention comprises a method of using a digital representation of a subject created by the process comprising: inputting, into a computer system, information sufficient to form a digital representation of the subject; deriving a digital representation of the subject from the information; assigning traits to the digital representation; encoding the representation with the traits and thus creating an encoded representation; and storing the encoded representation.

In some embodiments the use of the digital representation is selected from the group consisting of: family planning, trait recognition, dating, complex identity recognition and validation, DNA matching, eCommerce, virtual reality simulations, social networking, health and fitness analysis and monitoring, gaming, and child protection and identification.

In some embodiments, the information sufficient to form a digital representation of the subject is selected from the group consisting of: a single 2-D image of the subject, multiple 2-D images of the subject, Computer Axial Tomography scans of the subject, 3-D scans of the subject, and biological samples of the subject.

In some embodiments, the traits of the digital representation are selected from the group consisting of: the time the digital representation is created; the time a modification, enhancement, or supplement is made; identification of a modification, enhancement, or supplement; identification of the author of a modification, enhancement, or supplement; how a modification, enhancement, or supplement was made; the time a clone of the digital representation is made; who made a clone; where the clone was utilized; and security or access information.

In some embodiments, the digital representation is a three-dimensional likeness of the subject. In some embodiments, the three-dimensional likeness is extrapolated from the inputted information. In some embodiments, the digital representation is a representation of the subject's DNA.

In some embodiments, the subject is a living organism.

In some embodiments, the subject is a human being.

In some embodiments, the digital representation is cloned.

In some embodiments, the clone is given a certificate value of its own.

In some embodiments, the clone is encoded with traits.

In some embodiments, the clone is uploaded into a virtual reality simulation. In some embodiments, the virtual reality simulation is Second Life®.

In some embodiments, the clone is uploaded into a social networking website. In some embodiments, the social networking website is selected from the group consisting of: Windows Live®, Myspace®, and Facebook®.

In some embodiments, the clone is uploaded into a game system. In some embodiments, the clone is used as the avatar which represents the subject in a game system. In some embodiments, the game system is selected from the group consisting of: X-box®, Nintendo Wii®, and Playstation®.

In some embodiments, the clone is used as the avatar which represents the subject in online computer role-playing games. In some embodiments, the online computer role-playing games are selected from the group consisting of: World of Warcraft®, Guild Wars®, the Lord of the Rings Online®, the Matrix Online®, Star Wars Galaxies®, and Stargate Worlds®.

In some embodiments, the invention comprises a system capable of generating an adaptable digital representation of a subject. In some embodiments, the creation of the digital representation comprises inputting, into a computer system, information sufficient to form a digital representation of the subject. In some embodiments, a digital representation of the subject is derived from the information. In some embodiments, the system also comprises an encoder coupled to the code generator, the encoder encoding the representation with the traits of the digital representation. In some embodiments, the system also comprises a rules engine, which classifies the traits into codes. In some embodiments, the system also comprises a storage unit coupled to the encoder, the storage unit storing the encoded representation.

In some embodiments, the information sufficient to form a digital representation of the subject is selected from the group consisting of: a single 2-D image of the subject, multiple 2-D images of the subject, Computer Axial Tomography scans of the subject, 3-D scans of the subject, and biological samples of the subject.

In some embodiments, the traits of the digital representation are selected from the group consisting of: the time the digital representation is created; the time a modification, enhancement, or supplement is made; identification of a modification, enhancement, or supplement; identification of the author of a modification, enhancement, or supplement; how a modification, enhancement, or supplement was made; the time a clone of the digital representation is made, who made a clone, where the clone was utilized, and security or access information.

In some embodiments, a decoder is coupled to the storage unit, the decoder to decode the encoded representation. In some embodiments, the decoding of the encoded representation reveals the traits of the digital representation.

In some embodiments, the invention comprises a computer readable medium having an executable program stored thereon, wherein, in response to the inputting of sufficient information about a subject, the program comprises the steps of: deriving a digital representation of the subject; generating a code indicating information regarding the traits of the digital representation; encoding the digital representation by embedding the code in the digital representation; and storing the digital representation in a storage unit.

In some embodiments, the traits of the digital representation are selected from the group consisting of: the time the digital representation is created; the time a modification, enhancement, or supplement is made; identification of a modification, enhancement, or supplement; identification of the author of a modification, enhancement, or supplement; how a modification, enhancement, or supplement was made; the time a clone of the digital representation is made; who made a clone; where the clone was utilized; and security or access information.

In some embodiments, the program further comprises the step of decoding the digital representation to reveal the traits of the digital representation.

In some embodiments, the step of encoding the digital representation in the program includes embedding the code in the bit plane of the digital representation.

In some embodiments, the certificate value of the digital representation is also encoded in the bit plane of the digital representation.

### Figures

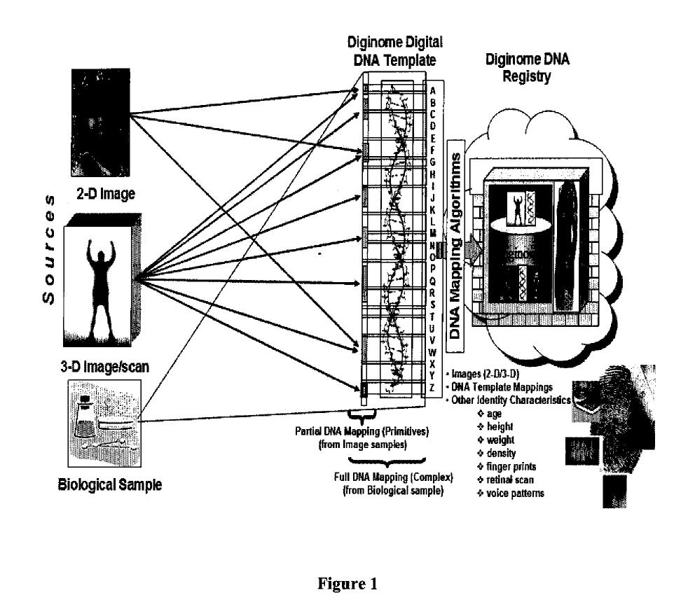

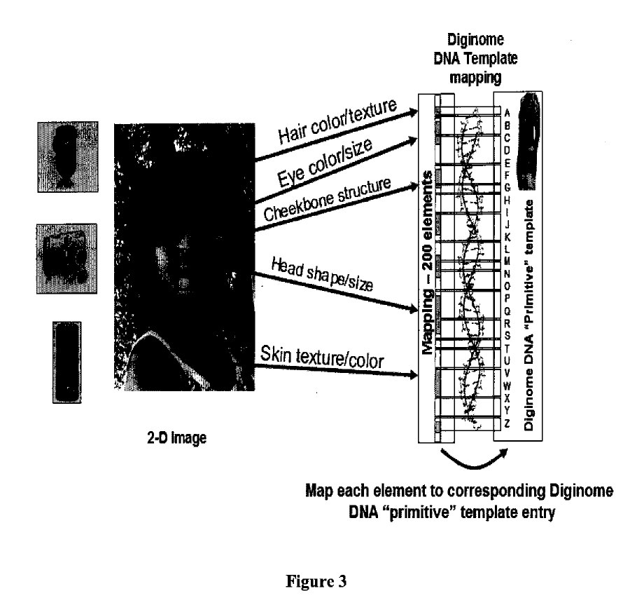

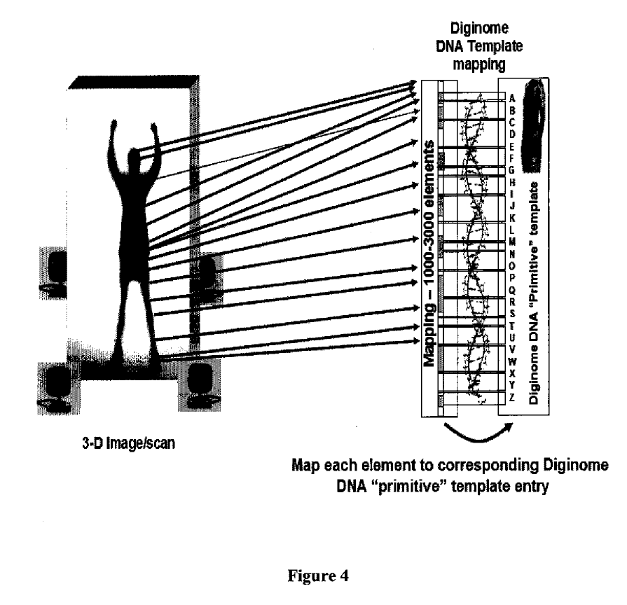

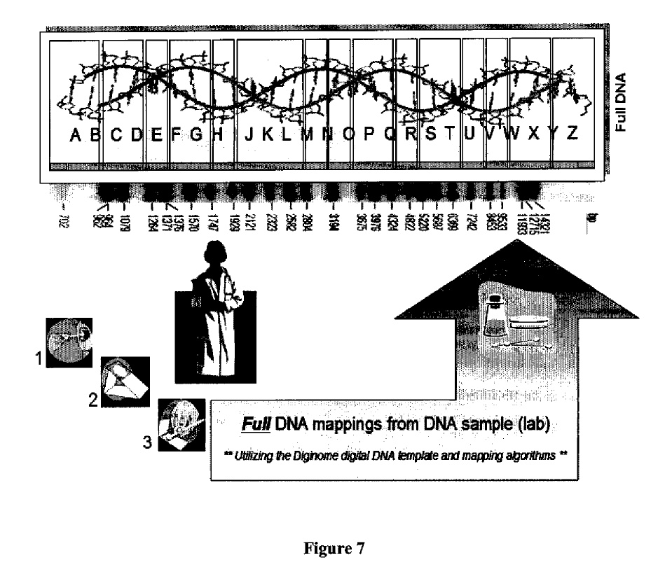

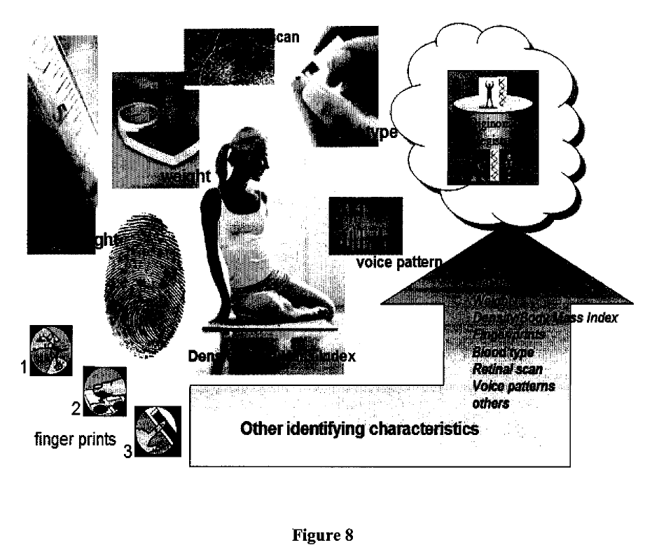

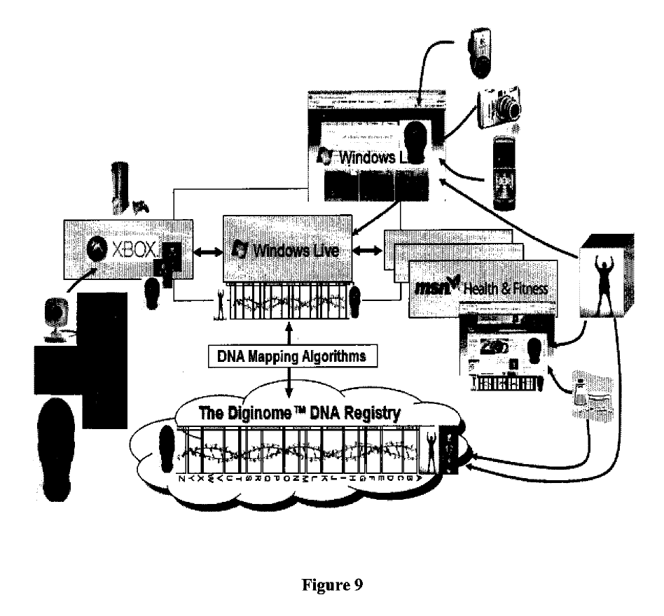

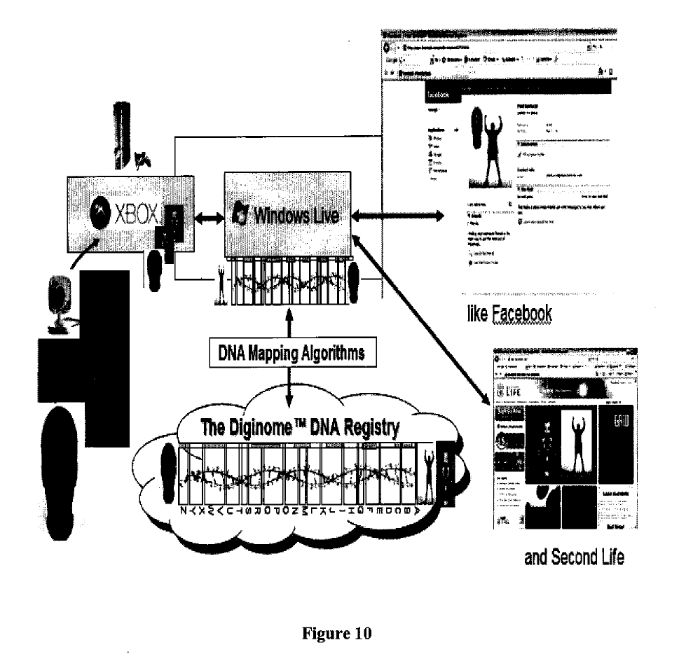

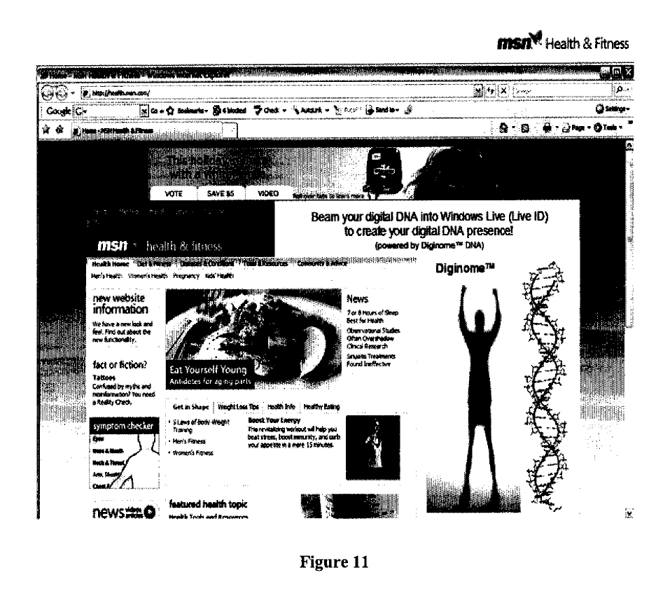

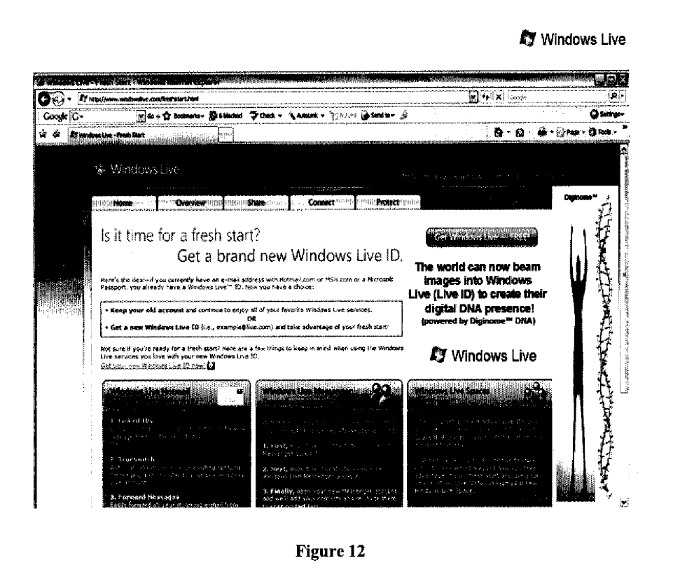

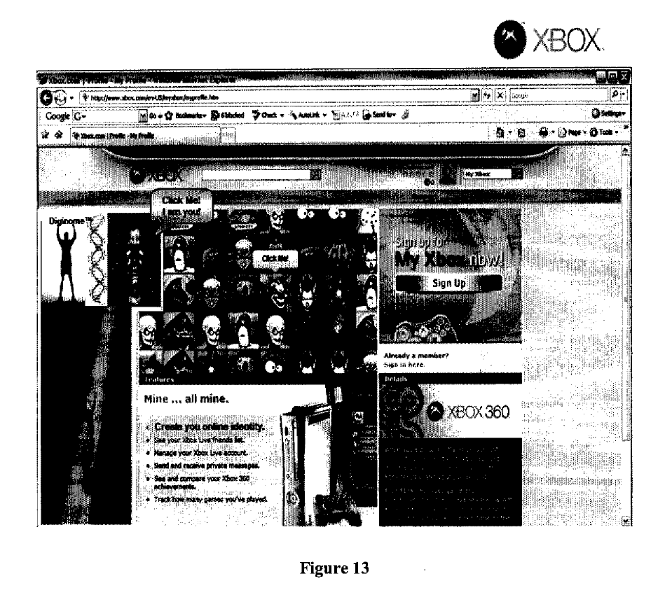

FIGS. 1-10 illustrate embodiments of the invention.

FIG. 1 illustrates the basic process of creating a digital representation of a human being, though that is only one embodiment of the invention. The invention is applicable to all non-digital subjects, especially all living organisms. The first step involves the client creating an account. When the account is created, the client is given a “key” or an obfuscated certificate. This will function much like a bank account and only the client will have access to the information.

Next, the client uploads one or more two-dimensional pictures into the system. Digital images may be directly uploaded into the system. Analog pictures will need to be scanned into a computer and then uploaded. The results of a three-dimensional scan, such as that produced by a CAT scan, may also be uploaded into the system. Additionally, the results of DNA sequencing maybe uploaded into the system.

If a two-dimensional picture(s) or a three-dimensional scan is used the information is mapped to a DNA “primitive” template. This involves extracting genetic information from physical characteristics. As of this date, there are approximately 200 physical characteristics that have accurate correspondence to DNA representations. For example, eye color can be extrapolated from a photograph. The eye color is then mapped to the eye color gene. If a three-dimensional scan is used, there are approximately 1000 to 3000 elements that can be mapped onto the “primitive” template.”

A new technique was also developed to improve the accuracy of the DNA mappings as more samplings are submitted. One 2-D photo with good pixel density (DPI) is a great start, however, when multiple images are provided that contain a sample of the same element (like eye color), this improves greatly the accuracy of the DNA mapping of that element by weighting the samples (based on clarity and DPI) and average out the samples (yielding a more precise eye color that will then be the “true” value we want to use to map to the DNA template).

Over time, it is expected that people will submit hundreds, if not thousands of their images to get as accurate representation of themselves as possible in the DNA registry. We term this the Quality Coefficient. As more samples are captured, the affect on the whole improves. All sampling “bites” will be retained within the DNA Registry (sampling bites are the tiny areas of an image that are being isolated for a particular element—like an eye color sampling bite).

If a DNA sequence is used, then the full genomic sequence is mapped to the DNA “complex” template. The information will be stored in two forms. First, the data will be stored in the “raw” digital form from the data that is provided from a certified DNA lab. Second, the information will be stored in summarized form as defined by the DNA “complex” template.

After the information has been uploaded and the templates mapped, a rendered three-dimensional digital representation of the client is created. If two-dimensional pictures are used, a program will extrapolate physical characteristics and measurements from the images to render the digital representation. This digital representation will be a likeness of the client. It can be cloned and uploaded into various games, both console-based and online. It can be used in virtual reality communities. It can also be uploaded onto social networking websites. This will allow the client to have an accurate representation of himself that other game players or community members can interact with, as opposed to a generic avatar chosen from a finite set of choices.

The information and digital representation can be further enhanced or supplemented by the client inputting, among other information, weight, height, birth date, gender, voice patterns, fingerprints, retinal scans, body mass index, blood type, blood sugar levels, blood pressure readings, and cholesterol levels.

The system can also be designed to mine the internet for information regarding the clients thus obviating the need for the client to initiate the modification, enhancement, or supplement of the digital representation.

Additionally, the digital representation could also automatically evolve through its digital interactions. By way of non-limiting example, if the digital representation is wounded in a video game, then the digital representation could be automatically modified, enhanced, or supplemented to display evidence of the wound. For example, the digital representation could carry a scar. The digital representation could also be programmed to realistically age.

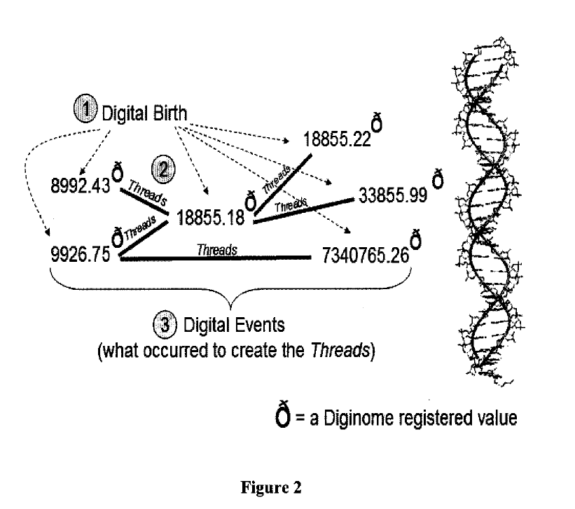

FIG. 2 illustrates the basic concept of tracking the traits of information. In FIG. 2, the information is a digit. A piece of data, 8992.43, is “birthed” as it is created within a computerized system. This data value and its entire data context are recorded within the registry. The recorded data characteristics include things like the data value's full business context, the timestamp of when it was created, where it came from, who (or what) designed it, and other information critical to its identity and its integrity verification. The Latin symbol eth, [symbol] , is used to indicate a registered value.

When anything acts on, changes or references any registered data value, threads (or associations) are generated that record these events and all characteristics (and context) of the event. This could include the original value and a new value (if it was changed, aggregated, deleted, or referenced in any way). FIG. 2 shows a thread between the data value of 8992.43 and the data value of 18855.18 because these two data values are related to each other in some way such as via aggregation, or modifications of some kind. Digital Events are the threads, combined with both the “parent” data value and the offspring (“child”) data value, and represent what has occurred along the data value's life. This is called the “digital heredity”. It is then possible to trace any data value throughout it's full digital heredity (from current usage back to its origins—like from 33855.99 back to 18855.18 back to 8992.43, so on).

Additionally, digital categorizations or traits can also be assigned to any information. As with biological heredity, these data traits can be inherited as either dominant or recessive. By way of non-limiting example, a trait might be the level of security or privacy attached to the information. If the trait is set as dominant, then any “offspring” of the data will also inherit that trait.

As applied to the digital representation and DNA templates, this technology allows the recordation of any modification, enhancement, or supplement, or cloning of the representation or DNA templates. The client can then view the entire history of his representation or DNA template. He could view the changes he has made, any changes the computer automatically made, or any changes that were unauthorized. He could also link to earlier digital representations from which the current representation was derived.

Additionally, the client can set as a trait, the security or privacy level of his digital representation or DNA template. He can then specify whether the trait will be dominant or recessive. If, for example, the trait is highly confidential and is dominant, then any clones of the digital representation or copies of the DNA template will also possess the trait of highly confidential. This will create a secure and undisputable place to capture, represent, and store any living organism's DNA digitally.

In some embodiments, the DNA Registry uses a predefined abstraction layer within the data mappings mechanism. This abstraction layer separates the detail elements that are being provided from the sources (photo images, scans, biological samples, so on) away from the targeted (and more stable) DNA templates (both for the primitive and complex templates). In this way, any number of new mappings can be added without affecting the DNA templates until they are ready to receive these properly mapped elements.

And, in reverse, if enhancements/changes occur to the DNA template, there may not be corresponding elements to draw on yet. When the mappings are added or enhanced the path is complete (from source elements to DNA template entries).

As new DNA sequencing and transcribing advances DNA representations, it is contemplated that the DNA Registry will add further mapping granularity along with additional transformation layers as needed.

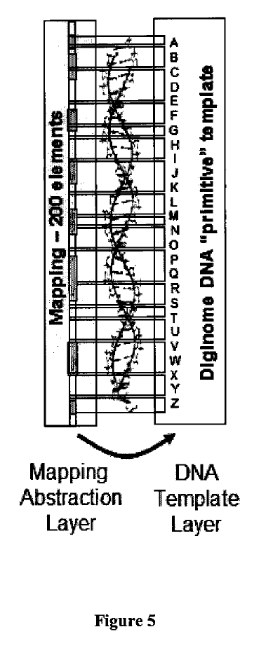

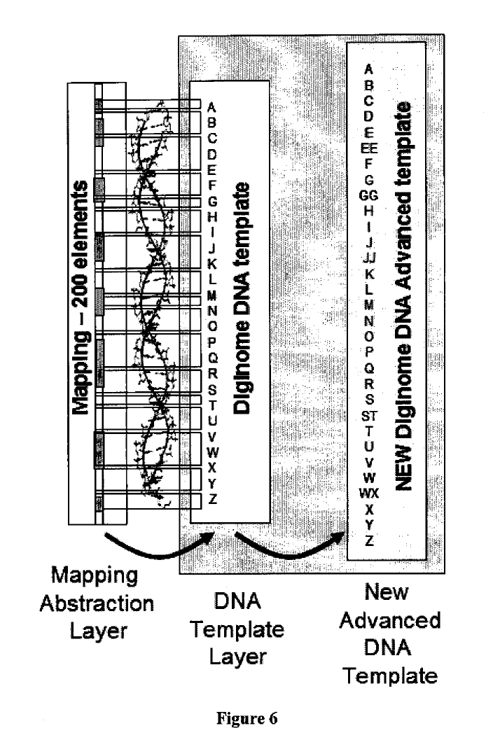

FIG. 5 and FIG. 6 show a new more advanced DNA transformation layer added to the registry that can embrace any level of complexity as it is added by the scientific community (for many years to come). Essentially, new mapping rules are added on top of existing mappings to correct or enhance this translation process as the scientific community improves on their techniques and practices. It is contemplated that embodiments of the invention can incorporate advances as they become available.

### EXAMPLES

Gaming

Gaming is an increasingly popular pastime. There are generally two types of gaming systems. The first is the traditional console-based gaming system. Examples are Nintendo's Wii®, Microsoft's X-Box®, and Sony's Playstation®. Several games for the console-based systems allow users to interact with other users over the internet. One such example is HALO® 3 which, in its first week, had estimated sales of $300 million. HALO® 3 is a first-person shooter game. The player “sees” through the eyes of his avatar. Other players see and interact with the avatars of fellow players.

There are also online computer role-playing games such as World of Warcraft® where players need only purchase the software to play. Currently, World of Warcraft® has approximately 8.5 millions users. The estimated 2007 revenues are $1.1 billion, with $520 million in operating profits. World of Warcraft® also involves the use of avatars to represent players.

After creating his digital representation, the client could upload his digital representation into a video game. Instead of interacting with the digital world through a generic avatar selected from a discrete set of choices, which other players also chose from, the client could instead use his unique digital representation as his avatar. Other players could then see and interact with the digital representation.

Social Networking

Multiple online social networking sites exist. The most popular are Myspace® and Facebook®. It is estimated that 12% of internet users are registered at a social networking site. Facebook®, alone, is estimated to have over 15 million users. Both sites allow users to upload photographs, among other things.

However, instead of a flat, two-dimensional photograph, the client could upload his digital representation onto the website. This could allow the client and others to interact through their digital representations. By way of non-limiting example, the digital representation could speak to visitors of the client's website, as opposed to simply having the client and visitor's interacting via typed messages.

Virtual Reality Simulations

Virtual reality simulations are an amalgam of social networking sites and online game playing. Sites such as Second Life® create online communities with rules similar to the real world where users interact with others. Users are represented by avatars and interact with the avatars of other users.

After creating his digital representation, the client could upload his digital representation into the virtual reality simulation. Instead of interacting with the virtual world through a generic avatar selected from a discrete set of choices, which other players also chose from, the client could instead use his unique digital representation as his avatar. Other players could then see and interact with the digital representation.

eCommerce

According to U.S. Census Bureau estimates, in the 1^{st} quarter of 2007 eCommerce sales totaled $31.4 billion. Second quarter sales totaled $33.6 billion. Third quarter sales totaled $34.7 billion. According to White House estimates annually approximately 10 million people are victims of identity theft. Losses each year often total $50 billion or more. There are many ways a person's identity may be stolen such as by use of spyware, viruses, or hackers breaching a secure network.

By way of non-limiting example, a client could use his DNA template as a form of identity verification. It could act as an alternative to a password, such that information could not be accessed until and unless the client's DNA were first verified. This could create a more secure system for protecting information; one which spyware, viruses, and hackers would find more difficult to defeat.

Family Planning

Family planning often requires pre-pregnancy screening for several genetic diseases which may be genetically inherited. Ty-Sachs disease, Sickle Cell Anemia, and Cystic Fibrosis are all autosomal recessive disorders which may be inherited when both parents posses a single copy of the defective gene. Hemophilia is an example of an X-linked recessive disorder which may be inherited by a male child if the mother possesses a single copy or by a female child if both the mother and father possess a copy.

The creation of a DNA template could obviate the need for pre-pregnancy genetic testing. After a DNA sequence is uploaded into the DNA “complex” template the client could be made aware of any genetic abnormalities and whether these could be passed onto a child. This could allow clients to engage in more accurate family planning.

Identity Verification

Facial recognition software identifies individuals based on a two-dimensional image captured from a video frame or digital image. Identifications are made by comparing certain facial features and measurements from the image in the database to the features and measurement in a video frame or digital image. Examples of features include the distance between eyes, the width of the nose, the depth of the eye sockets, the shape of cheekbones, and the width of the jaw line.

However, measurements derived from a two-dimensional image have limited accuracy. Instead, identities could be ascertained based on comparing an individual to his digital representation. This digital representation should produce more accurate comparison points than a single two-dimensional photograph. Furthermore, a use of a digital representation might better enable identification of individuals who attempt to obscure part of their physical characteristics by creating more points of comparison.

By way of non-limiting example, criminals could be scanned after arrest. The scans could be used to create a digital representation of the individual. These representations could then be placed in databases, and enhanced or supplemented by input of other characteristics such as fingerprints and blood type. These databases could then be made available to law enforcement and used in place of facial recognition software to identify criminals.

Illustrative embodiments are further described below.

A. Additive Approach in Building Up the Diginome DNA Registry Entries

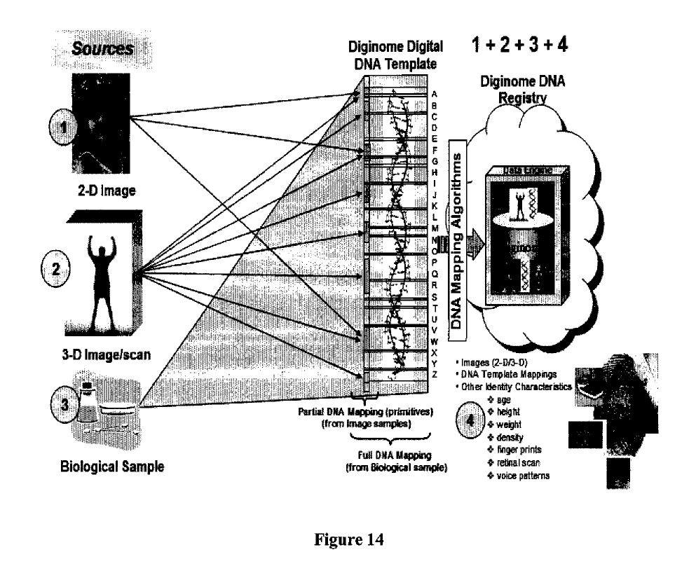

The Diginome DNA Registry has been designed to create an entry that is a composite object. This composite object can contain as minimal or as much registry information as is available or desirable. As more information from various sources is added to an entry in the registry, additional parts of the composite object are populated. An example below illustrated in FIG. 14 shows first (#1 below) a single 2-D image used to create the initial Diginome DNA Registry entry. A full transcription process is done and the composite object entry is created. If another source is added (#2 below from a 3-D image), additional information is transcribed into the current Diginome DNA Registry Entry but now, with much more detail (more element points from source). If a biological source is used (#3 above), many more elements are available that add much more to the composite object in the Diginome DNA Registry, including without limitation actual DNA sequences that represent individuals (or other living organisms). And, even more elements can come from “other” sources (as shown with #4) such as weight, so on. Again, adding to the composite object in the Diginome DNA Registry entry.

B. Multiple Samples Improve the Outcome Using a Weighting Method

The Diginome DNA Registry has also been designed to improve its registry entries as more and/or additional sources are identified. In particular, a smoothing and a weighting process has been defined to use the highest quality source sample elements available along with averaging (smoothing) two or more source sample elements to achieve the optimal element sourcing. These optimized source elements are what are used to in the transcription process to the Diginome DNA Registry (Primitives).

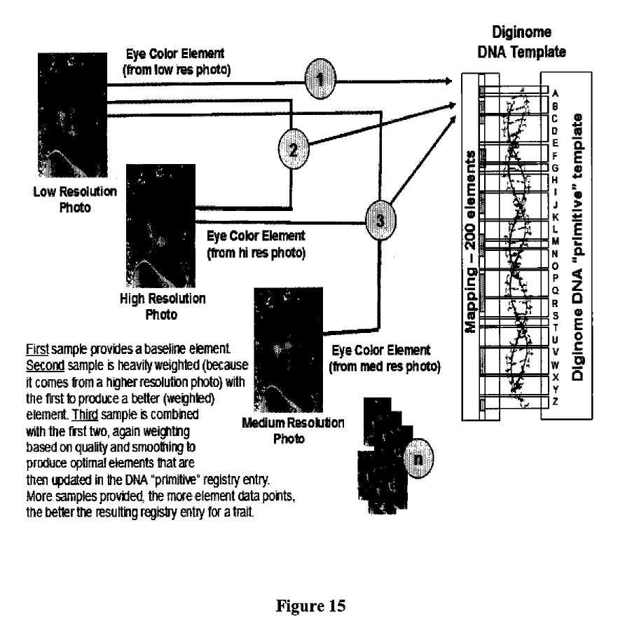

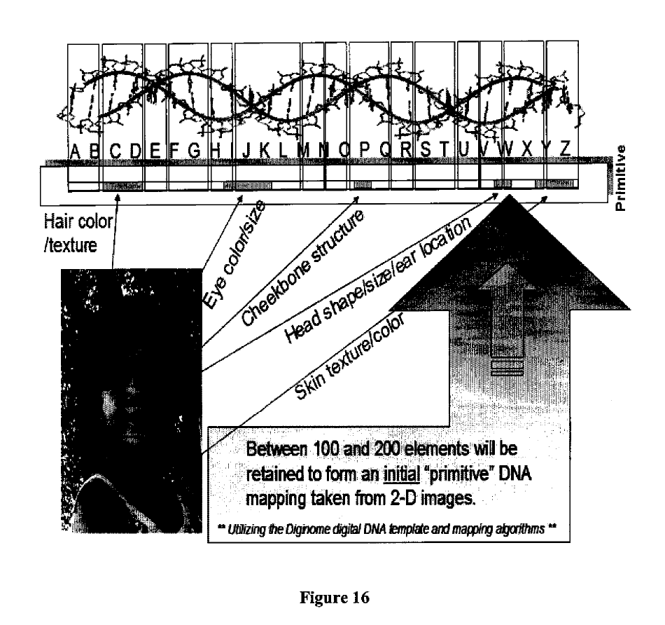

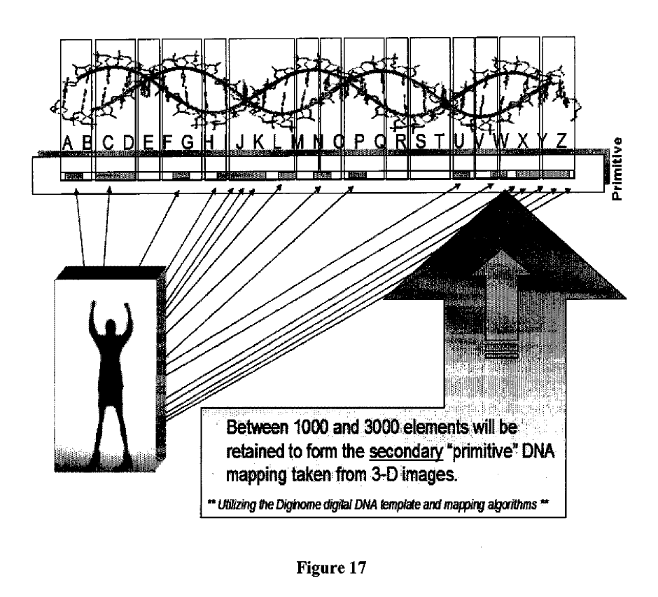

As shown in FIG. 15, an initial 2-D image source from a low resolution photo may be used as the first source that generates a Diginome DNA Registry entry (#1). An additional 2-D image of much higher resolution is later used and is averaged with the original source. Because the image may be of much higher resolution, one may assign a strong weight to it that will dominate the resulting source element value (as seen in #2). A third photo of medium resolution (#3) may also be used and will be averaged into (smoothed) into the overall source element value improving the overall result that much more. This process may be repeated to achieve a desired mapping quality. The more samples, the more data points, the better the resulting source element for mapping to the DNA Template primitive.

C. Source to Diginome DNA Registry Entry Processing

The sampling of sources and the full transcription of sampling elements may be generalized into the following steps:
1) Source Sampling isolation of elements
2) Source Sampling processing to a normalized element (that can be mapped)
3) And, Source Sampling element transcription/mapping to DNA Template groups/items

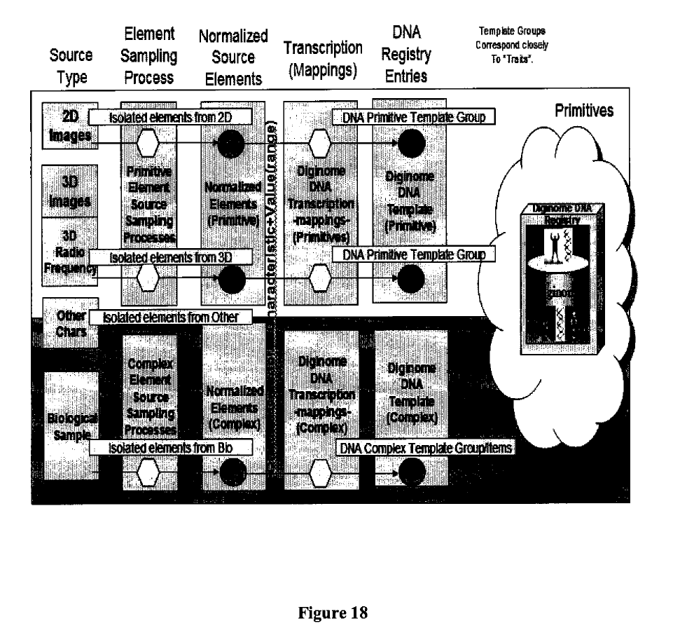

For any 2-D or 3-D sources one end result may be that of a DNA “Primitive” registry entry. As illustrated in FIG. 18, the process may start with the Source type, isolating a particular element from specific sampling areas within the Source Type, and converting this into a normalized source element that can be consistently transcribed (mapped) to the target DNA Template. This mapping into the DNA Template (groups) becomes the DNA Registry entry.

Other characteristics, such as weight, blood type may follow the same type of path but may end up as extended attributes of the composite object that is the DNA Registry entry (into DNA Primitive Template Groups).

Original images used as sources may be automatically carried along and make a part of the DNA Registry entry as well.

Biological samples follows the same path (processing) as other Source Types, but may retain vastly more source elements and are transcribed to a DNA Complex Template that is designed to hold these types of results (to DNA Complex Template Groups/Items).

D. Diginome DNA Registry Entries (Details) and the Privacy Zones Within the Registry

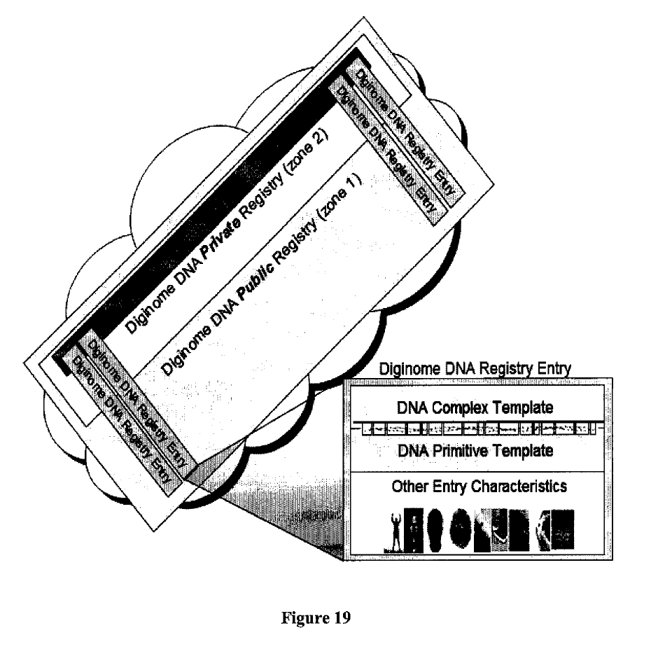

As you as shown in FIG. 19 (lower right), a single Diginome DNA Registry entry may be a composite object that contains not only two types of DNA template groups (primitive and complex templates), but also many include other entry characteristics (such as weight, height, finger prints, so on). There is no limit to these extended attributes. This also includes any (or all) source images used and specific isolated samples from these images.

Also illustrated in FIG. 19 are three zones of privacy and security protection on the DNA Registry entries. A particular Diginome DNA Registry Entry potentially spans all three zones but may only exposes particular parts of itself that match the desired zone. As an example, the simulated gaming image that represents a clone of an entry may be available to be seen by anyone (in the Public registry zone (zone 1)). Whereas, a full DNA Complex Template group would be drastically protected and restricted (only exposed for Restricted use (Zone 3)). All levels/zones of security/protection are controlled by only the owner of the DNA Registry entry.

E. Sampling/Harvesting from the Whole DNA Registry

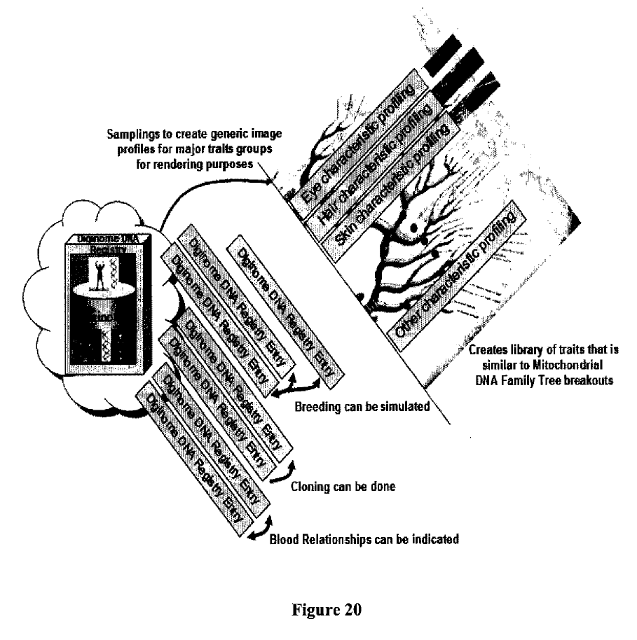

A method to crawl (carefully step through) through all of the DNA Registry entries looking for specific traits or characteristics and at the same time carefully categorizing these traits into their proper profiled groupings was devised to add greater and more accurate rendering of captured DNA Registry entries. FIG. 20 shows one embodiment to harvest out standard sampling areas from DNA Registry entries that may form a generalized library of standard rendering traits.

Aspects such as eye colors, eye shapes, skin tones, so on may be carefully generalized and stored for more accurate rendering later. It is contemplated that the process may render an image of an entry using statistical information from the DNA Registry Entry along with these generalized image traits (characteristic profiling library for a trait). The library of these traits and the categorization of these into a tree structure is akin to the Mitochondrial DNA Family Tree breakouts. This becomes a human tree characteristics library that would have a branch for each major ethnic race, numerous smaller branches from each large branch that would represent specific sub races or regional characteristics. This will allow the system provided herein to get more and more accurate on any virtual cloning or breeding that we do (both in DNA form, and in digital rendering) and very accurately (and more accurately over time) be able to show “real” regional characteristics for the human race. The more samples (DNA Registry entries) occur, the more accurate is the process. Also noted in FIG. 20 is the ability to capture blood relationships between entries (like parent/child relationships, or sibling relationships), as well as generating simulated breeding results of two entries that produce a new (bred) entry.

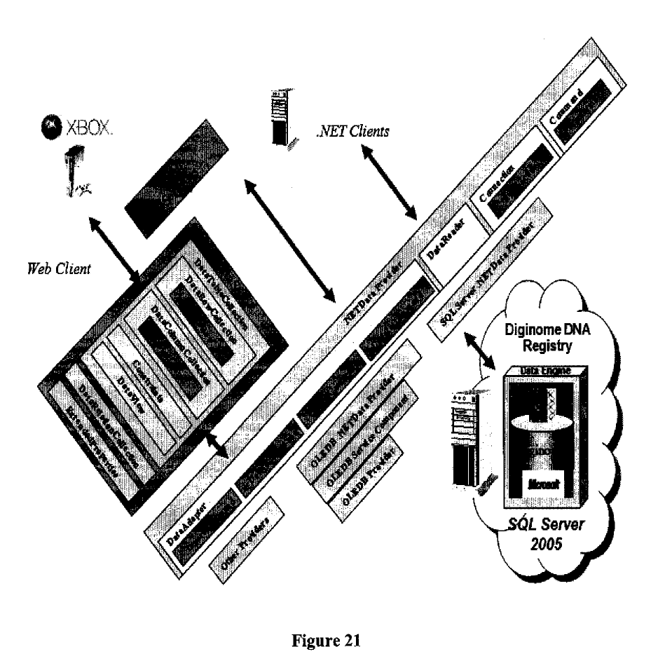

FIG. 21 illustrates a system for implementing the registry described herein.

F. Rendering Options, Usage, and Leveraging Dominant Traits

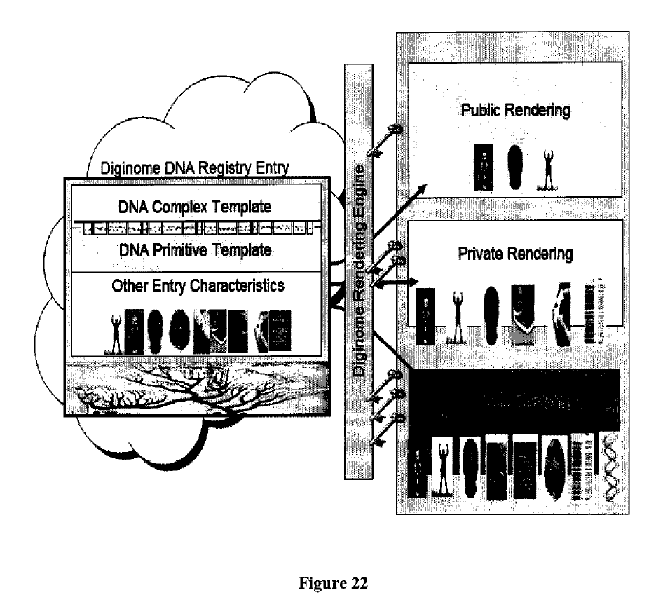

Utilizing profiling characteristics library (that are actually taken from “real subjects” from around the world) an application rendering algorithm is employed to properly draw on the best fit images and also adjust certain images (weights them more strongly) to correspond to dominant traits. If a particular characteristic can be shown to be slightly more dominant (from live examples captured in a Diginome DNA Registry), then weighting is adjusted to correspond to actual dominance levels in the population (and not on theory). This type of dominance detection is ascertained as Parent/Child entries are collected. The image samples are then mined across types of heredity relationships. FIG. 22 shows a rendering engine component that is pulling information from both the DNA Registry Entry (DNA Complex/Primitive templates, and other Entry Characteristics) along with leveraging the profiling characteristics library. Both are used in the rendering process.

As shown in FIG. 22, rendering may be applied to the same type of highly controlled landing zones. Public rendering is limited to aspects that do not need much control (such as a simulation/virtual image). Private rendering is more tightly controlled in its consumers and has more rendering types (eCommerce/minor health useful characteristics, such as height, weight, blood type, so on). As well, very restricted rendering is applied for identity purposes. Each level of rendering is accessed/opened up and used by increasingly number of access (locking) mechanisms.

For example, eye shape may be part of an image that will be rendered. Eye shape might be a basic oval (typical of western Europeans). One person's image/DNA entry may be subjected to breeding with someone else from Asia (eyelids slightly different, eye shape is slightly less oval, more tear drop shaped). In one embodiment, rendering may employ a library of the subjects primary images (the father and mother's eye image sample), along with a rich library of both western European eye shape images, and Asian eye shape images). A dominance weightings for this type of breeding may be applied to the digital rendering that would be a very likely offspring rendering (weighted properly). As the Diginome DNA Registry increases in its population, the weighting and resulting renderings become more and more accurate. All rendering into images can be employed in a variety of applications. Computer Game identity renderings, simple jpeg/gif renderings for 2-D usage, are only some of the illustrations, without limitation.

While the preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method for creating an adaptable digital representation of a subject, comprising:
a. inputting into a computer system information sufficient to form a digital representation of the subject;
b. deriving a digital representation of the subject based on the information;
c. assigning traits to the digital representation;
d. encoding the representation with the traits of the digital representation creating an encoded representation; and
e. storing the encoded representation.

2. The method of claim 1, wherein the information sufficient to form a digital representation of the subject is selected from the group consisting of: a single 2-D image of the subject, multiple 2-D images of the subject, Computer Axial Tomography scans of the subject, 3-D scans of the subject, DNA material obtained from the subject, and biological samples of the subject.

3. The method of claim 1, wherein the traits of the digital representation are selected from the group consisting of: the time the digital representation is created; the time a modification, enhancement, or supplement is made; identification of a modification, enhancement, or supplement; identification of the author of a modification, enhancement, or supplement; how a modification, enhancement, or supplement was made; the time a clone of the digital representation is made, who made a clone, where the clone was utilized, and security or access information.

4. The method of claim 1, wherein the digital representation is a three-dimensional likeness of the subject.

5. The method of claim 4, wherein the three-dimensional likeness is extrapolated from the inputted information.

6. The method of claim 1, wherein the digital representation is a representation of the subject's DNA.

7. The method of claim 1, wherein the digital representation is a representation comprises a DNA sequence determined from the subject's DNA.

8. The method of claim 1, wherein the subject is a living organism.

9. The method of claim 1, wherein the subject is a human being.

10. The method of claim 1, wherein the information derived from the two-dimensional images or three-dimensional scans is selected from the group consisting of: hair color, hair texture, hair length, location of the hair line, eye color, eye size, eye shape, eye location, nose shape, nose location, mouth shape, mouth size, mouth location, head shape, head size, ear location, skin texture, and skin color.

11. The method of claim 1, wherein genetic information is extrapolated from physical characteristics.

12. The method of claim 1, wherein the digital representation of the human being is enhanced or supplemented by additional information about the physical characteristics or biometrics of the subject.

13. The method of claim 12, wherein the additional information is selected from the group consisting of: age, height, weight, body mass, finger prints, retinal scans, blood type, voice patterns, gender, birth date, blood sugar levels, blood pressure, and cholesterol levels.

14. The method of claim 1, further comprising continuously or periodically modifying, enhancing, or supplementing the digital representation while preserving record of prior embodiments of the digital representation.

15. The method of claim 14, wherein the information is weighted in accordance of preset preferences.

16. The method of claim 14, wherein the digital representation is modified, enhanced, or supplemented by user input.

17. The method of claim 14, wherein the digital representation is automatically modified, enhanced, or supplemented by the system.

18. The method of claim 17, wherein the system periodically mines for information related to the subject.

19. The method of claim 17, where the information is mined from sources selected from the group consisting of: the internet, private databases, and public databases.

20. The method of claim 17, wherein the information is segmented into privacy zones within a registry.

21. The method of claim 21, wherein the privacy zones comprise one or more restricted zones that are not accessible to the general public.

22. The method of claim 17, wherein the system automatically modifies, enhances, or supplements the digital representation based upon the mined information.

23. A method of using a digital representation of a subject, wherein the digital representation is a process comprising:
a. inputting into a computer system information sufficient to form a digital representation of the subject;
b. deriving a digital representation of the subject based on the information;
c. assigning traits to the digital representation;
d. encoding the representation with the traits of the digital representation creating an encoded representation; and
e. storing the encoded representation; and
wherein the use of the digital representation is selected from the group consisting of: family planning, trait recognition, dating, identity recognition and validation, DNA matching, eCommerce, virtual reality simulations, social networking, health and fitness analysis and monitoring, gaming, and child protection and identification.

24. The method of claim 23, wherein the information sufficient to form a digital representation of the subject is selected from the group consisting of: a single 2-D image of the subject, multiple 2-D images of the subject, Computer Axial Tomography scans of the subject, 3-D scans of the subject, and biological samples of the subject.

25. The method of claim 23, wherein the traits of the digital representation are selected from the group consisting of: the time the digital representation is created; the time a modification, enhancement, or supplement is made; identification of a modification, enhancement, or supplement; identification of the author of a modification, enhancement, or supplement; how a modification, enhancement, or supplement was made; the time a clone of the digital representation is made; who made a clone; where the clone was utilized; and security or access information.

26. The method of claim 23, wherein the digital representation is a three-dimensional likeness of the subject.

27. The method of claim 26, wherein the three-dimensional likeness is extrapolated from the inputted information.

28. The method of claim 23, wherein the digital representation is a representation of the subject's DNA.

29. The method of claim 23, wherein the subject is a living organism.

30. The method of claim 23, wherein the subject is a human being.

31. The method of claim 23, wherein the digital representation is cloned.

32. The method of claim 31, wherein the clone is given a certificate value.

33. The method of claim 31, wherein the clone is encoded with traits.

34. The method of claim 31, wherein the clone is uploaded into a virtual reality simulation.

35. The method of claim 34, wherein the virtual reality simulation is Second Life®.

36. The method of claim 31, wherein the clone is uploaded into a social networking website.

37. The method of claim 36, wherein the social networking website is selected from the group consisting of: Windows Live®, Myspace®, and Facebook®.

38. The method of claim 31, wherein the clone is uploaded into a game system.

39. The method of claim 31, wherein the clone is the avatar used to represent the subject in a game system.

40. The method of claim 39, wherein the game system is selected from the group consisting of: X-box®, Nintendo Wii®, and Playstation®.

41. The method of claim 31, wherein the clone is the avatar used to represent the subject in online computer role-playing games.

42. The method of claim 41, wherein the online computer role-playing games are selected from the group consisting of: World of Warcraft®, Guild Wars®, the Lord of the Rings Online®, the Matrix Online®, Star Wars Galaxies®, and Stargate Worlds®.

43. A system capable of generating an adaptable digital representation of a subject, comprising:
a. inputting into a computer system information sufficient to form a digital representation of the subject;
b. a program which derives a digital representation of the subject based upon the inputted information;
c. a code generator which generates code representing the traits of the digital representation;
d. a rules engine, which classifies the traits into codes;
e. an encoder coupled to the code generator, the encoder encoding the representation with the information regarding the characteristics of the digital representation; and
f. a storage unit coupled to the encoder, the storage unit storing the encoded representation.

44. The system of claim 43, wherein the information sufficient to form a digital representation of the subject is selected from the group consisting of: a single 2-D image of the subject, multiple 2-D images of the subject, Computer Axial Tomography scans of the subject, 3-D scans of the subject, and biological samples of the subject.

45. The system of claim 43, wherein the traits of the digital representation are selected from the group consisting of: the time the digital representation is created; the time a modification, enhancement, or supplement is made; identification of a modification, enhancement, or supplement; identification of the author of a modification, enhancement, or supplement; how a modification, enhancement, or supplement was made; the time a clone of the digital representation is made; who made a clone; where the clone was utilized; and security or access information.

46. The system of claim 43, further comprising a decoder coupled to the storage unit, the decoder to decode the encoded representation.

47. The system of claim 43, wherein the decoding of the encoded representation reveals the traits of the digital representation.

48. A computer readable medium having an executable program stored thereon, wherein, in response to the inputting of sufficient information about a subject, the program comprises the steps of:
a. deriving a digital representation;
b. generating a code representing the traits of the digital representation;
c. encoding the digital representation by embedding the code in the digital representation; and
d. storing the digital representation in a storage unit.

49. The computer readable medium of claim 48, wherein the traits of the digital representation are selected from the group consisting of: the time the digital representation is created; the time a modification, enhancement, or supplement is made; identification of a modification, enhancement, or supplement; identification of the author of a modification, enhancement, or supplement; how a modification, enhancement, or supplement was made; the time a clone of the digital representation is made; who made a clone; where the clone was utilized; and security or access information.

50. The computer readable medium of claim 48, wherein the program further comprises the step of decoding the digital representation to establish the traits of the digital representation.

51. The computer readable medium of claim 48, wherein the step of encoding the digital representation in the program includes embedding the code in the bit plane of the digital representation.

52. The computer readable medium of claim 48, wherein the certificate value of the digital representation is also encoded in the bit plane of the digital representation.
